(19) United States
(12) Patent Application Publication
(10) Pub. No.: US 2011/0271083 A1
(43) Pub. Date: Nov. 3, 2011

(54) MICROPROCESSOR ARCHITECTURE AND METHOD OF INSTRUCTION DECODING

(75) Inventors: Martin Raubuch, Baldham (DE); Norbert Stoeffler, Grafelfing (DE)

(73) Assignee: FREESCALE SEMICONDUCTOR, INC., AUSTIN, TX (US)

(21) Appl. No.: 13/142,431

(22) PCT Filed: Jan. 21, 2009
(86) PCT No.: PCT/IB09/50215

§ 371 Date: Jun. 28, 2011

(51) Int. Cl. G06F 9/30

(52) U.S. Cl. 712/208; 712/E09.028

(57) ABSTRACT

A microprocessor architecture comprises an instruction decoding network for decoding in a first mode partially suppressed opcodes of a sequence of instructions, the opcodes comprising a first part containing parameters being invariant for each opcode of the sequence and a second part comprising a flag indicating an end of the sequence, the first part being suppressed for all opcodes of the sequence except a first opcode of the sequence. Further, a method of instruction decoding in a microprocessor architecture comprising an instruction decoding network for decoding in a first mode partially suppressed opcodes of a sequence of instructions, and in a second mode uncompressed instructions comprises decoding an opcode of an instruction in the second mode when the instruction is not compressible; and decoding an opcode of an instruction in the first mode when the instruction is compressible.

### FIELD OF THE INVENTION

This invention in general relates to microprocessor architectures and more specifically to partial opcode suppression for microprocessors.

### BACKGROUND OF THE INVENTION

The most common function performed by digital signal processing algorithms, for example used in digital image and video processing applications, is the sum-of-products calculation. For an execution of sum-of-product calculations in software, a sequence of MAC (Multiply & Accumulate) instructions may be used for efficient implementation. MAC instructions multiply a sample, i.e. a digitized signal value, by a constant, i.e. a coefficient, and add the product to an accumulator register. Typically both the constant and the sample operands are different for each MAC instruction of a sum-of-product sequence. This is why Digital Signal Processors (DSPs) usually have two data buses to be able to fetch both a sample and a constant per clock cycle and execute a MAC instruction in effective one clock cycle. However, classical DSP architectures with a dual data-memory architecture may require a large memory subsystem around them.

DSP like performance may be achieved using normal, i.e. non-DSP microprocessor architectures with a single data bus by coding the constants into the MAC instruction words. In other words, the instruction bus may be used as a secondary data bus. A drawback of this approach is the resulting code size since such instruction sequences for sum-of-products calculation can not be implemented using program loops. Different approaches using memory tables may enable usage of program loops, but at the cost of lower performance (2 memory reads per MAC).

An approach without program loops may generate significant redundancy in the instruction codes, since only the constants vary between the instructions of a sequence, while other parameters such as the instruction type (e.g. MAC), the specification of the accumulator register, non-constant source-operand specifications (e.g. memory indirect with auto-increment) etc. may be the same for an entire instruction sequence that computes a single sum-of-products.

### SUMMARY OF THE INVENTION

The present invention provides a microprocessor architecture and a method of instruction decoding in a microprocessor architecture as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Identical reference numerals in different figures refer to identical or similar components.

FIG. 1 shows a schematic block diagram of an example of an embodiment of a microprocessor architecture.

FIG. 2 shows a schematic diagram of an example of an opcode.

FIG. 3 shows a schematic diagram of an example of a sequence of instructions with and without partial opcode suppression.

FIG. 4 shows a schematic flow diagram of an example of a method for instruction decoding in a microprocessor architecture.

FIG. 5 shows a schematic block diagram of an example of a vehicle comprising an advanced driver assistance system with a system-on-a-chip comprising a microprocessor architecture.

### DETAILED DESCRIPTION OF THE PREFERRED EMBODIMENTS

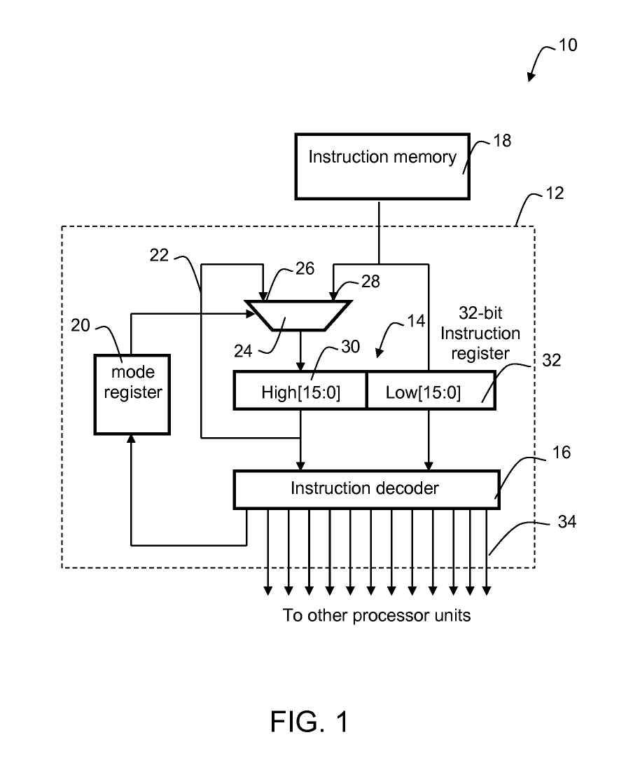

Referring to FIG. 1, a schematic block diagram of an example of an embodiment of a microprocessor architecture is illustrated. Because the illustrated embodiments of the present invention may for the most part, be implemented using electronic components and circuits known to those skilled in the art, details will not be explained in any greater extent than that considered necessary as illustrated below, for the understanding and appreciation of the underlying concepts of the present invention and in order not to obfuscate or distract from the teachings of the present invention.

The microprocessor architecture 10 comprises an instruction decoding network 12 for decoding in a first mode partially suppressed opcodes of a sequence of instructions. The opcodes comprise a first part containing parameters being invariant for each opcode of the sequence and a second part comprising a flag indicating an end of the sequence. The first part is suppressed for all opcodes of the sequence except a first opcode of the sequence.

An opcode (operation code) is the portion of a machine language instruction that specifies the operation to be performed.

Partial suppression of the first part of an opcode may be most efficient when long sequences of instructions are to be processed by the microprocessor, with each opcode comprising changes only in the second part of the opcode code word. Therefore, the sequence of instructions may be a sequence of multiply-and-accumulate (MAC) instructions. MAC instructions may be an important part of the instructions sent to the instruction decoder. For example, a typical code for object recognition applications may contain a high share of sum-of-products calculations, for example more than 80%. MAC instructions may be used for sum-of-products calculations which are the most frequently used calculations, for example used by image or video processing algorithms.

The instruction decoder may be capable in a second mode or normal operation mode of decoding uncompressed opcodes. Uncompressed opcodes contain both the second and the first part of the opcode. No part may be suppressed. When in the first or compressed mode, the microcontroller architecture may switch to the second or uncompressed mode with the first partial compressed opcode that has an end-of-sequence flag set.

The microprocessor architecture may comprise an instruction memory 18 connected to the instruction decoding network 12 for providing the partially suppressed opcodes of a sequence of instructions to the instruction decoding network 12. The instruction memory 18 may store both compressed and uncompressed instructions and may provide a stream of instructions.

The instruction decoding network 12 may receive a stream of encoded instructions, usually from an instruction memory 18 which may be coupled to an instruction bus. The instruction decoding network decodes the received instructions and may provide the decoded instructions to other units of the microprocessor architecture.

The instruction decoding network 12 may comprise an instruction register 14 receiving in the first mode partially suppressed opcodes and providing opcodes comprising the first part of the first opcode of the sequence and the second part of the received partially suppressed opcode to an instruction decoder 16. The instruction decoder may receive a full (for example a full 32-bit) instruction word both in the first or compressed and in the second or uncompressed modes and may provide decoded instructions to other processing units through an interface 34. The instruction register 14 may be capable of storing a higher and a lower codeword part 30, 32. For example, a 32-bit instruction register may store a 16 bit higher codeword part and a 16-bit lower codeword part. In the first or compressed mode the higher 16-bit word of the instruction register may be frozen, i.e. held constant, after loading an opcode having a flag disclosing that the received opcode is not the end of a sequence of opcodes, and only the lower 16-bit word may loaded with 16-bit compressed (partial) opcodes from the instruction memory 18.

The instruction decoding network may comprise a mode register 20 enabling in the first mode a feedback loop 22 for keeping a previously stored first part in the instruction register 14. The first or compressed mode maybe entered and the mode register may be set with the first instruction of a partially compressed sequence. The mode register 20 may be a 1-bit mode register. The mode register 20 may be set by the instruction decoder 16. The mode register may be connected to the instruction decoder 16 receiving a current mode of operation information and providing the information to a multiplexer 24, connected to keep the upper code word loaded during operation in the first or compressed mode. In the first mode, the feedback loop 22 may be used to re-insert the currently stored first part, i.e. the shown 16-bit high codeword part into the register 14, while in the second mode a new full instruction codeword may be written to the instruction register 14. For this, the multiplexer 24 may have an output connected to the instruction register and first input 26 for receiving in the first mode or compressed sequence mode the currently stored higher codeword 30 and a second input 28 for receiving in the second mode or normal operation mode a new higher codeword from the instruction memory 18.

A microprocessor may be any processing unit and may for example be any kind of microprocessor, a central processing unit (CPU), a graphics processing unit (GPU), a microcontroller, or a digital signal processor (DSP). Although the described opcode suppression may be applied to any processor architecture, the provided increase of code density may be most valuable when using the instruction bus also as a secondary data bus. Therefore, the microprocessor architecture may comprise a single data bus. It may for example comprise exactly one primary data bus, not two, such as provided with dual data bus DSPs.

With the shown microprocessor architecture, the redundant part in sequences of instructions such as MAC instructions may be suppressed and the overall code size may be the same as for dual data-bus DSPs and the shown microprocessor architecture having an instruction bus and a single data bus may allow for achieving a similar performance and code density as DSP architectures having an instruction bus and dual data buses.

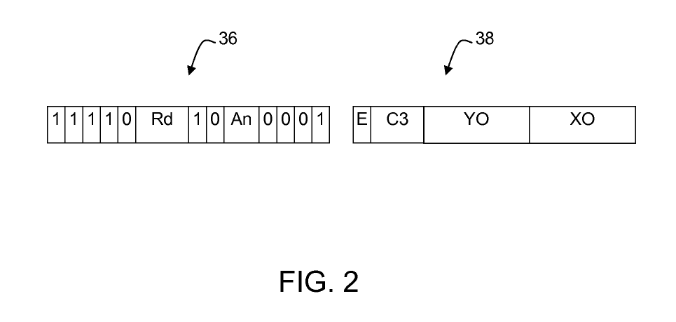

Referring now to FIG. 2, a schematic diagram of an opcode is shown. The shown example refers to a mac (multiply & accumulate) instruction 32-bit opcode. However, any other opcode code word lengths are possible, for example 16 or 64 bit.

The opcode is split into two parts 36, 38. The first part 36 contains the parameters that are fixed across an instruction sequence. The shown first part, i.e. the first 16-bit word, contains the fixed parameters Rd and An. Rd may be the destination register (accumulator), An may be the indirect address register for a memory operand. Other fixed information may be contained, such as the instruction type (e.g. MAC). The shown first part 36 may be suppressed for the second and following mac instructions of a sequence of instructions.

The second part 38 may contain a variable part. The shown second 16-bit word for example contains a vertical address offset Y0, a horizontal address offset X0 and a source operand C3 which may be a constant or coefficient to be used for a sum-of-product calculation. Therefore, the second part may comprise a coefficient value of a multiply-and-accumulate (MAC) instruction.

And it may contain the flag E that indicates the end of the sequence having partially suppressed opcodes.

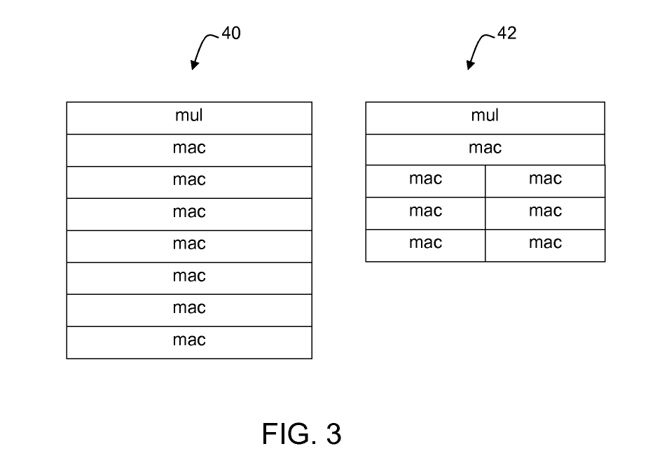

Referring now to FIG. 3, a schematic diagram of an example of a sequence of instructions with and without partial opcode suppression is illustrated. The diagram shows a sequence of one multiply (mul) instruction followed by 7 mac instructions. The left part 40 of the diagram shows a sequence without partial opcode suppression. For the shown example, when using 32-bit opcodes, the shown sequence without suppression may require 32 bytes. The right part 42 of the diagram shows a corresponding sequence, but with only the first mac instruction comprising both opcode parts, the following six opcodes having their first opcode part being suppressed. The first mac instruction of a sequence has the full instruction code (both parts) and the end-of-sequence flag may be cleared indicating that more instructions with identical first parts will follow. For the remaining instructions of the sequence the first part of the instruction word is suppressed. The last instruction of the sequence may have the end-of-sequence flag set. Thus, the shown example of a compressed sequence may have only 20 bytes compared to 32 bytes without partial opcode suppression.

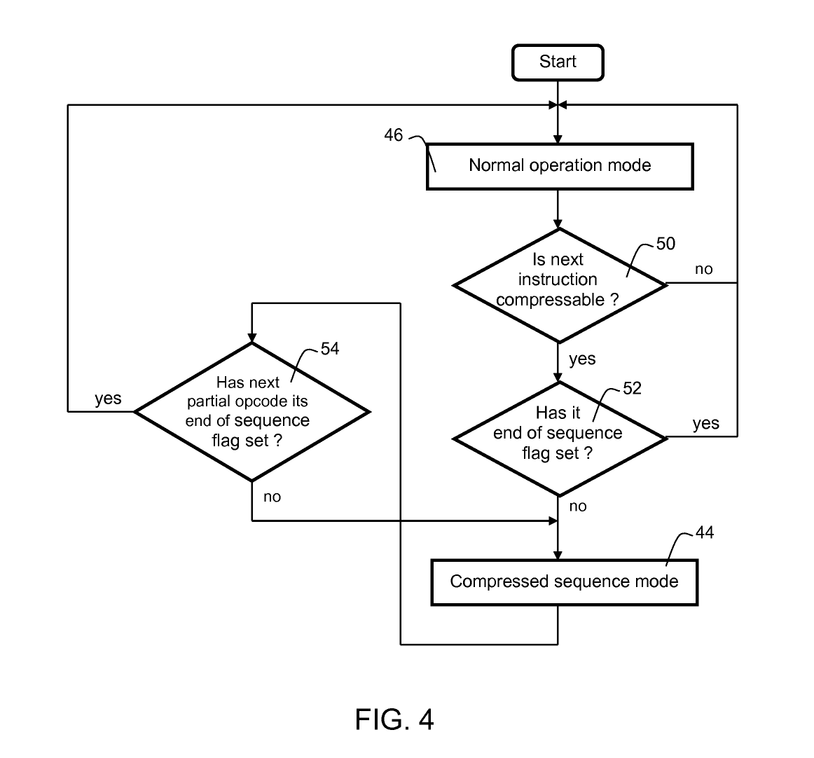

Referring now to FIG. 4, a schematic flow diagram of an example of a method for instruction decoding in a microprocessor architecture is illustrated. The illustrated method allows implementing the advantages and characteristics of the described microprocessor architecture as part of a method of instruction decoding in a microprocessor architecture, which comprises an instruction decoding network for decoding in a first mode 44 partially suppressed opcodes of a sequence of instructions, and in a second mode 46 uncompressed instructions. The instruction decoding method comprises decoding 50 an opcode of an instruction in the second mode or normal operation mode when the instruction is not compressible; and decoding 52 an opcode of an instruction in the first mode or compressed sequence mode when the instruction is compressible. An instruction is said to be compressible when the instruction type allows for a compressed or an uncompressed version (full opcode or partially suppressed opcode). The first instruction of a compressed sequence may be uncompressed.

When in normal operation mode 46, an evaluation, whether or not the next instruction is compressible may be applied. If the instruction is not compressible, the system remains in normal operation mode, otherwise the system switches to first mode or compressed sequence mode, if no end of sequence flag is set.

The system may switch from the first mode or compressed sequence mode to the second mode or normal operation mode when a flag contained in the opcode indicates that an end of the sequence has been reached 54.

The opcodes of compressible instructions may comprise a first part containing parameters being invariant for each opcode of the sequence and a second part comprising a flag indicating an end of the sequence. The method then may comprise suppressing the first part for all opcodes of compressible instructions of the sequence except for a first opcode of the sequence.

For many applications it may be desired to have the shown microprocessor architecture integrated in a system-on-a-chip, comprising the microprocessor architecture or implementing a method as described above.

Many applications may use a microprocessor architecture as described above in order to achieve DSP like performance using a single data bus microprocessor architecture instead of a DSP. The described microprocessor architecture may for example be used in image and video processing applications such as video surveillance or object recognition applications or advanced driver assistance systems (ADAS). ADAS may be In-vehicle navigation systems. Video-based ADAS such as adaptive cruise control (ACC), lane departure detection/warning systems, lane change assistance, intelligent speed adaptation or intelligent speed advice (ISA), night vision systems, pedestrian protection systems, or driver drowsiness detection systems may benefit from using the described solution. Therefore, an advanced driver assistance system (ADAS) may comprise a system-on-a-chip or a microprocessor architecture or may implement a method of instruction decoding in a microprocessor architecture as described above.

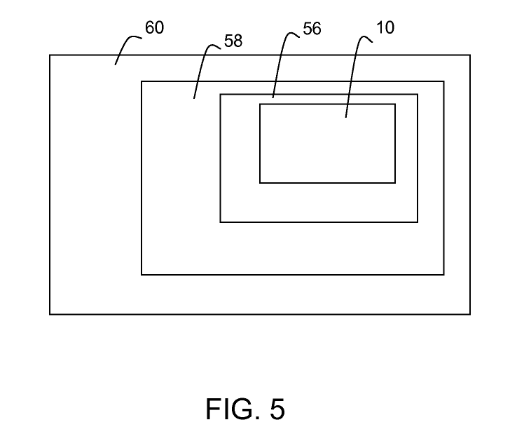

Referring now also to FIG. 5, a schematic block diagram of an example of a vehicle 60 is shown. The vehicle 60 comprises an advanced driver assistance system 58 using a system-on-a-chip 56 comprising a microprocessor architecture 10. It is an example for a vehicle that may comprise a system-on-a-chip or an advanced driver assistance system or a microprocessor architecture as described above. A vehicle may be a car. However, it may be any other vehicle such as a truck, a motor bike, a train, a ship, a helicopter, a plane, or a bicycle.

A computer program product may comprise code portions for executing steps of a method as described above when run on a programmable apparatus.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system. The computer program may be provided on a data carrier, such as a CD-rom or diskette, stored with data loadable in a memory of a computer system, the data representing the computer program. The data carrier may further be a data connection, such as a telephone cable or a wireless connection.

In the foregoing specification, the invention has been described with reference to specific examples of embodiments of the invention. It will, however, be evident that various modifications and changes may be made therein without departing from the broader spirit and scope of the invention as set forth in the appended claims. For example, the connections may be any type of connection suitable to transfer signals from or to the respective nodes, units or devices, for example via intermediate devices. Accordingly, unless implied or stated otherwise the connections may for example be direct connections or indirect connections.

Also, at least portions of the architecture may be implemented using a programmable logic device (PLD), e.g. a field programmable gate array (FPGA), an application specific integrated circuit (ASIC) etc., or as a program code executable by a processing device, such as a digital signal processor (DSP), a microcontroller unit (MCU), a general purpose processor (GPP), a central processing unit (CPU), a graphics processing unit (GPU) etc.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Some of the above embodiments, as applicable, may be implemented using a variety of systems. For example, although FIG. 1 and the discussion thereof describe an exemplary microprocessor architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Also for example, in one embodiment, the illustrated elements of the microprocessor architecture are circuitry located on a single integrated circuit or within a same device. Alternatively, the microprocessor architecture 10 may include any number of separate integrated circuits or separate devices interconnected with each other.

Also for example, microprocessor architecture 10 or portions thereof may be soft or code representations of physical circuitry or of logical representations convertible into physical circuitry. As such, microprocessor architecture 10 may be embodied in a hardware description language of any appropriate type.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

While the principles of the invention have been described above in connection with specific apparatus, it is to be clearly understood that this description is made only by way of example and not as a limitation on the scope of the invention.

1. A microprocessor architecture, comprising:
an instruction decoding network configured to decode, in a first mode, partially suppressed opcodes of a sequence of instructions, said opcodes comprising
a first part containing parameters being invariant for each opcode of said sequence, and
a second part comprising a flag indicating an end of said sequence, said first part being suppressed for all opcodes of said sequence except a first opcode of said sequence.

2. The microprocessor architecture as claimed in claim 1, wherein said sequence of instructions comprises a sequence of multiply-and-accumulate (MAC) instructions.

3. The microprocessor architecture as claimed in claim 1, wherein said instruction decoding network is further configured to decode, in a second mode, uncompressed instructions.

4. The microprocessor architecture as claimed in claim 1, wherein said instruction decoding network comprises: an instruction register configured to
receive, in said first mode, partially suppressed opcodes, and
provide opcodes comprising said first part of said first opcode of said sequence and said second part of said received partially suppressed opcode to an instruction decoder.

5. The microprocessor architecture as claimed in claim 1, further comprising:
an instruction memory, connected to said instruction decoding network, and configured to provide said partially suppressed opcodes of a sequence of instructions to said instruction decoding network.

6. The microprocessor architecture as claimed in claim 4, wherein the instruction decoding network comprises:
a mode register configured to provide, in said first mode, a feedback loop for keeping a previously stored first part in said instruction register.

7. The microprocessor architecture as claimed in claim 1, wherein said second part comprises a coefficient value of a multiply-and-accumulate (MAC) instruction.

8. The microprocessor architecture as claimed in claim 1 comprising a single data bus.

9. A method of instruction decoding in a microprocessor architecture comprising an instruction decoding network for decoding in a first mode partially suppressed opcodes of a sequence of instructions, and in a second mode uncompressed instructions, the method comprising:
decoding an opcode of an instruction in said second mode when said instruction is not compressible; and
decoding an opcode of an instruction in said first mode when said instruction is compressible.

10. The method as claimed in claim 9 comprising:
switching from said first mode to said second mode when a flag contained in said opcode indicates that an end of said sequence has been reached.

11. The method as claimed in claim 9, said opcodes of compressible instructions comprising a first part containing parameters being invariant for each opcode of said sequence and a second part comprising a flag indicating an end of said sequence, said method comprising
suppressing said first part for all opcodes of compressible instructions of said sequence except for a first opcode of said sequence.

12-14. (canceled)

15. A computer-readable storage medium storing instructions executable by a microprocessor architecture, the instructions comprising:
a first set of instructions configured to decode an opcode of an instruction in a second mode when said instruction is not compressible; and
a second set of instructions configured to decode an opcode of an instruction in a first mode when said instruction is compressible, wherein
the microprocessor architecture comprises an instruction decoding network configured to decode, in the first mode, partially suppressed opcodes of a sequence of instructions, and, in the second mode, uncompressed instructions.

16. The computer-readable storage medium of claim 15 storing further instructions, the instructions comprising:
a third set of instructions configured to switch from said first mode to said second mode when a flag contained in said opcode indicates that an end of said sequence has been reached.

17. The computer-readable storage medium of claim 15 storing further instructions, the instructions comprising:
a third set of instructions configured to suppress a first part of an opcode of compressible instructions of said sequence except for a first opcode of said sequence, wherein
the opcodes of compressible instructions comprise a first part comprising invariant parameters for each opcode of said sequence and a second part comprising a flag indicating an end of said sequence.

18. The microprocessor architecture as claimed in claim 3, wherein said instruction decoding network comprises:
an instruction register configured to
receive, in said first mode, partially suppressed opcodes, and
provide opcodes comprising said first part of said first opcode of said sequence and said second part of said received partially suppressed opcode to an instruction decoder.

19. The microprocessor architecture as claimed in claim 4, further comprising:
an instruction memory, connected to said instruction decoding network, and configured to provide said partially suppressed opcodes of a sequence of instructions to said instruction decoding network.

20. The microprocessor architecture as claimed in claim 2, wherein said second part comprises a coefficient value of a multiply-and-accumulate (MAC) instruction.

21. The microprocessor architecture as claimed in claim 4, wherein said second part comprises a coefficient value of a multiply-and-accumulate (MAC) instruction.

22. The microprocessor architecture as claimed in claim 4 comprising a single data bus.

23. The microprocessor architecture as claimed in claim 19 comprising a single data bus.
